(19) United States
(12) Patent Application Publication
(10) Pub. No.: US 2006/0042955 A1
(43) Pub. Date: Mar. 2, 2006

(54) Arc-hydrolysis fuel generator with supplemental energy recovery

(76) Inventor: Victor M. Villalobos, Marietta, GA (US)

Correspondence Address: MYERS & KAPLAN, INTELLECTUAL PROPERTY LAW, L.L.C., 1899 POWERS FERRY ROAD, SUITE 310, ATLANTA, GA, 30339, US

(21) Appl. No.: 11/029,119

(22) Filed: Jan. 4, 2005

Related U.S. Application Data
(60) Provisional application No. 60/605,706, filed on Aug. 30, 2004.
(60) Provisional application No. 60/607,770, filed on Sep. 7, 2004.
(60) Provisional application No. 60/610,072, filed on Sep. 15, 2004.
(60) Provisional application No. 60/615,975, filed on Oct. 5, 2004.

(51) Int. Cl. C25C 1/02

(52) U.S. Cl. 205/628

(57) ABSTRACT

An arc-hydrolysis fuel generator and method of use thereof, the generator comprising an inductor placed around an arc-hydrolysis unit, wherein the inductor recovers. magnetic energy generated by the electric arc discharge to supplement the energy recoverable from the hydrogen and/or carbon monoxide/dioxide fuel generated from water and/or biomass by the arc-hydrolysis unit. The arc-hydrolysis fuel generator may further comprise a water vapor recovery system, a steam generation system and/or a gas liquefying system, utilizing fuel generated by the arc-hydrolysis fuel generator during use.

### PRIORITY CLAIM

To the fullest extent permitted by law, the present non-provisional patent application claims priority to, and the full benefit of the following co-pending applications: (1) provisional patent application entitled “Water Fueled Pneumatic Energy Storage and Generator Apparatus”, filed on Aug. 30, 2004, having assigned Ser. No. 60/605,706; (2) provisional patent application entitled “Self-sustaining Arc-hydrolysis Gaseous Fuel Generator”, filed on Sep. 7, 2004, having assigned Ser. No. 60/607,770; (3) provisional patent application entitled “Self-sustaining Arc-hydrolysis Gaseous Fuel Generator”, filed on Sep. 15, 2004, having assigned Ser. No. 60/610,072; and provisional patent application entitled “Multiple Use Self-sustaining Arc-hydrolysis Gaseous Fuel Generator”, filed on Oct. 5, 2004, having assigned Ser. No. 60/615,975.

### TECHNICAL FIELD

The present invention relates generally to fuel generators, and more specifically to a gaseous fuel generator and process for generation of combustible fuel and energy therefrom, wherein the fuel is generated by arc-hydrolysis of water and/or biomass, and wherein supplemental electrical energy is recovered from an electrical arc via induction.

### BACKGROUND OF THE INVENTION

As concerns about our nation's dependence on foreign oil increase, and as Americans become more aware of the resulting direct effect on the economy of the country and of environmental impacts of foreign petroleum use, interest has increased for domestically-produced alternative methods for fueling transportation engines, as well as methods for generation of electrical energy.

Hydrogen gas is often considered as an excellent fuel source, because its combustion in oxygen causes it to return to its original water compound form while producing energy, thereby providing a source of clean energy. Because water is comprised of hydrogen and oxygen, it is an excellent source of hydrogen for utilization as such a clean fuel, requiring only the cleaving apart, or lysing, of the two elements.

Electrolysis has long been a method of choice to break compounds into their component molecules. Hydrolyzing water through the use of electrical energy at electrodes is electrolysis, in this instance, of water. By subjecting water to a pair of electrodes, a cold or low voltage anode and a hot or high voltage anode, there will result the formation of oxygen and hydrogen gases.

Normally, electrolysis of water carried out at an anode-cathode pair is a slow process, in part limited by the resulting hydrogen and oxygen gases forming a layer around the electrodes through which water must migrate to reach the electrode. As the gases rise, clearing the electrode surface, water again contacts the anode and cathode and undergoes hydrolysis.

In order to provide for more rapid electrolysis of water, it is desirable to pump more energy into the water surrounding the electrodes to thereby break apart more water molecules rapidly. One method of providing a large amount of energy through electrodes is via an electric arc.

Electric arcs are utilized in various well-known devices, such as light bulbs, vacuum tubes, welding, and the like. Additionally, electric arcs have been utilized for ionization and/or hydrolysis of water, wherein the energy released in the formation of the spark breaks apart the water molecule into its component hydrogen and oxygen elements.. In hydrolyzing water, the arc must take place under water and is thus known as arc-hydrolysis. The hydrogen produced can subsequently be stored or utilized as a fuel, while the oxygen can be stored or released harmlessly into the atmosphere. Arc-hydrolysis has been utilized in water and other liquids, including biomass, wherein other gases than hydrogen may result. Biomass hydrolyzed may include, but is not limited to, starches, human or animal waste, sugars, alcohols, and/or combinations of these.

In addition to hydrogen, other gases are useful as fuels. One such gas is carbon monoxide, often existing in combination with carbon dioxide, known as “reducing gas”. Arc-hydrolysis of water at a carbon anode will result in the production of hydrogen at the cold anode, and carbon monoxide and carbon dioxide at the hot anode, wherein the temperature of the hot anode reaches approximately 6000 degrees Fahrenheit.

In order to stabilize the pattern of dependency on foreign oil, in addition to creating employment in a new industry, it is desirable to both generate synthetic fuels and to recover electrical energy utilized in producing the fuels.

While energy utilized in production of hydrogen and/or carbon monoxide/dioxide can be recovered through combustion, there is a substantial amount of energy lost in the process of producing the fuel. Accordingly, it is advantageous to make the arc-hydrolysis process more efficient and/or to recover the lost energy through other means. Efficiency improvement has been accomplished by adding salts to the water to facilitate ionic transfer between the electrodes. However, there remains a substantial quantity of energy waste in the electric arc discharge.

Additionally, previous devices and methods disadvantageously consume great quantities of water; in particular, 1500 gallons per hour water is needed for a 50 KWh unit.

Therefore, it is readily apparent that there is a need for an apparatus and method for generation of gaseous fuel via arc-hydrolysis, with supplemental recovery of waste energy residing in the arc discharge and extraction of heat energy from the solution for recovery of water produced by the combustion of fuel.

### BRIEF SUMMARY OF THE INVENTION

Briefly described, in a preferred embodiment, the present invention overcomes the above-mentioned disadvantages and meets the recognized need for such a device by providing an arc-hydrolysis fuel generator with supplemental energy recovery, via an inductor, from the magnetic field formed by an arc discharge utilized for electrolyzing water and/or biomass. The arc-hydrolysis gaseous fuel generator of the present invention recovers waste energy and water vapor that would otherwise be lost, thereby providing for higher efficiency of conversion of electrical energy to fuel.

According to its major aspects and broadly stated, the present invention in its preferred form is an arc-hydrolysis fuel generator and method of use thereof, wherein an inductor is placed around an arc-hydrolysis unit, and wherein the inductor recovers magnetic energy generated by the electric arc discharge, to supplement the recoverable energy, via combustion, from the hydrogen and/or carbon monoxide/dioxide fuel generated. The recovered energy is returned to the arc-hydrolysis unit, whereby the recovered energy reduces the quantity of electrical energy required to provide a subsequent arc discharge. It is noted that the fuel is produced concurrent with the electrolysis/magnetic energy recovery.

Additionally, water vapor exhausted by an internal combustion engine is recovered and returned to the water/biomass process tank, thereby reducing the quantity of water and biomass required to produce energy.

More specifically, the present invention is an arc-hydrolysis fuel generator with supplemental energy recovery and process therefor, wherein a source material, such as water or liquid biomass, in a controlled pressure container is subjected to an electric arc discharge. Submerged arc-hydrolysis utilizes a high voltage controlled pulse to produce a spark, or arc, in a solution comprised of water and carbon material, whereby the solution is ionized into gaseous fuel comprised of carbon monoxide and hydrogen (CO/H₂) via the application of a high electrical voltage across carbon, or other, anodes.

The gaseous fuels produced are stored in a pressurized tank and are subsequently fed to an internal combustion engine, wherein an electrical generator is driven by the internal combustion engine, thereby producing electrical energy for use in sustaining the process of the present invention or for export to electrical energy-using devices. It will be recognized by those skilled in the art that mechanical energy from the internal combustion engine could selectively be utilized with or without producing electrical energy via electrical generator. The internal combustion engine provides rotational energy, such as for pumping water, or powering a vehicle. Alternately, by connecting a generator to the internal combustion engine, electrical energy can be produced.

An absorption refrigeration unit is utilized to condense and recycle water vapor into water, wherein the absorption refrigeration unit is powered by heat generated from the electric arc produced by the arc-hydrolysis unit and process of operation thereof.

Magnetic field energy is recovered from the electric arc discharge and converted into electrical energy by an inductor, to increase the efficiency of the arc-hydrolysis gaseous fuel generator.

The arc-hydrolysis gaseous fuel generator with supplemental energy recovery of the present invention is well suited to generating carbon monoxide-hydrogen fuel (CO/H₂) from a mixture of water and a carbon-rich biomass solution, such as, for exemplary purposes only, alcohols, sugars, starches, carbohydrates, and the like. The gaseous fuel (CO/H₂) is generated via ionization of the water and rich-carbon biomass solution upon exposure to a high voltage electrical arc, wherein the hydrogen is displaced by the formation of carbon monoxide that extracts the oxygen from the solution. The volume of carbon monoxide-hydrogen (CO/H2) produced is proportional to the size of the arc-electrolysis reactor, the spark size and the amount of electric voltage producing the arc discharge.

The gases formed, CO and H₂, are both suitable, individually and together, as fuels for combustion, preferably in internal combustion engines. When CO/H₂ is combined with eight parts of air, it combusts cleanly and results in by-product water vapor and carbon dioxide. Although atmospheric oxygen can be utilized for burning CO/H₂ when burning pure H₂ from electrolysis of water, oxygen generated in the electrolysis can alternately be utilized to minimize the need for atmospheric oxygen.

In addition to fueling engines, the heat produced by the arc-hydrolysis can be utilized as an environmentally desirable method to clean and disinfect water or organic materials contaminated by bacteria, and/or desalinize water.

In order to achieve maximization of the desired results of the present invention, it is necessary to recapture the waste energy that would normally be lost from the arc discharge. The electric arc discharge forms an electromagnetic pulse, wherein the electromagnetic pulse is produced when a high voltage direct current pulse is discharged across a spark gap. The pulse is steady, extremely short in duration, and sharp in nature, with fast, abrupt interruption to produce the greatest magnetic field for capture by an inductor.

A highly visible light effect is produced when the cold low voltage anode is exposed to the high-voltage anode (as high as 3000 volt) positive potential. When the low voltage switch on the low voltage side is open, a high voltage positive potential forms across anodes, wherein electrons are drawn to the anodes, and, subsequently, when a switch is quickly closed and re-opened (as short as 0.00005 sec), an arc forms at the arc point between the low voltage anode and the high voltage anode of approximately 3000 volt potential. A plasma is formed from the arc discharge, wherein the plasma ionizes a solution therearound, takes place and the electrons give up quanta or photons of electromagnetic nature, yielding a highly visible luminous light.

Specifically, the steady stream of sharp direct current pulses promotes ionization of the solution atoms during the upward leg of the pulse while creating, an arc plasma condition and a pulsating electromagnetic radiant event in the downward leg of the pulse as it collapses. The high voltage direct current pulses produced across the arc point are sharply interrupted, abrupt and very short in duration (0.00005 sec to 0.01 sec), to obtain a maximum ratio of ionization rate to recycling rate of electric energy.

The steady direct current pulses across the anodes generate two concurrent events:

a) solution is converted into gaseous fuel and oxidizer, including CO O₂, and/or H₂ gas; and,

b) an electromagnetic radiant pulsating field, wherein the pulsating field is subsequently utilized to recover electric energy by use of a metal collector comprising an inductor.

These two concurrent events tend to promote each other, first, by producing a gaseous fuel, and a pulsating arc plasma condition, and second, by producing an electromagnetic radiant field effect.

The arc-hydrolysis gaseous fuel generator with supplemental energy recovery recaptures most of the electrical energy utilized to produce the arc discharge and, additionally, can be augmented by recovery of water vapor, recycling approximately 90% of the water utilized.

Accordingly, a feature and advantage of the present invention is its ability to produce hydrogen gas.

Another feature and advantage of the present invention is its ability to produce carbon monoxide and hydrogen gas in combination.

Still another feature and advantage of the present invention is its ability to harvest the waste energy created during arc-hydrolysis through utilization of a magnetic field.

Yet another feature and advantage of the present invention is its ability to desalinize water, while concurrently generating fuel.

Yet still another feature and advantage of the present invention is ability to recycle animal and/or vegetable waste, while concurrently generating fuel.

A further feature and advantage of the present invention is its ability to selectively generate heat, while concurrently generating fuel.

Still a further feature and advantage of the present invention is its ability to provide cyclical energy motion for pumping.

Yet a further feature and advantage of the present invention is its ability to provide motive power.

Still yet a further feature and advantage of the present invention is its usefulness for bacteriological control of waters, while concurrently generating fuel.

Still yet another feature and advantage of the present invention is that it approaches near self-sufficiency.

An additional feature and advantage of the present invention is its ability to sterilize liquid materials.

Still an additional feature and advantage of the present invention is its ability to recover water.

Yet an additional feature and advantage of the present invention is that it requires only addition of biomass and/or water for self-sufficiency.

Still yet an additional feature and advantage of the present invention is that it minimizes the depletion of atmospheric oxygen.

These and other features and advantages of the present invention will become more apparent to one skilled in the art from the following description and claims when read in light of the accompanying drawings.

### BRIEF DESCRIPTION OF THE DRAWINGS

The present invention will be better understood by reading the Detailed Description of the Preferred and Selected Alternate Embodiments with reference to the accompanying drawing figures, in which like reference numerals denote similar structure and refer to like elements throughout, and in which:

FIG. 1 is a block diagram of an arc-hydrolysis gaseous fuel generator according to the preferred embodiment of the present invention;

FIG. 2 is a cross-sectional view of a submerged arc-hydrolysis reactor component of an arc-hydrolysis gaseous fuel generator according to the preferred embodiment of the present invention;

FIG. 3A is an energy flow diagram of a prior art arc-hydrolysis gaseous fuel generator;

FIG. 3B is an energy flow diagram of an arc-hydrolysis gaseous fuel generator according to the preferred embodiment of the present invention;

FIG. 4 is a schematic diagram of the electrical circuitry of an arc-hydrolysis gaseous fuel generator according to the preferred embodiment of the present invention;

FIG. 5 is a partial cross-sectional view, with block diagram including water/biomass supply system and liquid feed tanks, of an arc-hydrolysis gaseous fuel generator according to the preferred embodiment of the present invention;

FIG. 6 is a block diagram of a vapor recovery component of an arc-hydrolysis gaseous fuel generator according to the preferred embodiment of the present invention;

FIG. 7 is an electrical/rotational energy optimization process diagram of an arc-hydrolysis gaseous fuel generator according to the preferred embodiment of the present invention;

FIG. 8A is a detail partial cross-sectional view depicting flow of reactants and products of an arc-hydrolysis gaseous fuel generator according to the preferred embodiment of the present invention;

FIG. 8B is a detail partial cross-sectional view depicting flow of cooling water of an arc-hydrolysis gaseous fuel generator according to an alternate embodiment of the present invention;

FIG. 9 is block diagram of a liquefying process of an arc-hydrolysis gaseous fuel generator according to an alternate embodiment of the present invention; and,

FIG. 10 is a block diagram of a steam/electricity generation process of an arc-hydrolysis gaseous fuel generator according to an alternate embodiment of the present invention.

### REFERENCE NUMERALS IN THE DRAWINGS

10 Arc-hydrolysis gaseous fuel generator
100 Supply system
100.1 Water supply
100.2 Biomass supply pipe
100.2.1 Biomass supply inlet
100.3 Biomass return pipe
100.3.1 Biomass supply outlet
100.4 Biomass return pump
100.5 Biomass container tank
100.6 Water supply tank
100.7 Electrolyte recirculation tank
100.8 Biomass supply valve
100.9 Water supply valve
100.10 Recycled water supply
100.11 Solid trap tank
100.12 Biomass supply pump
100.13 Carbon-containing biomass liquid waste
100.23 Biomass liquid waste pipe
100.24 Cooling water inlet
100.25 Cooling water outlet
100.26 Water jacket
100.27 Cold water
200 Fuel generation system
200.1 Arc-hydrolysis reactor unit
200.1.1 Arc point
200.2 Metal collector
200.2.1 Collector cable
200.4 Top pressure seal ring
200.4.1 Low voltage cold anode
200.5 Hot electrode seal ring
200.5.1 High voltage hot anode
200.6 Fiber feed casing
200.7 Pressure reducing valve control
200.9 Hot electrode cable
200.10 Cold electrode cable
200.14 Mixed fuel(air and CO/H₂)
200.19 Gaseous fuel collector
200.19.1 Fuel/air mixer
200.20 Liquid level
200.22 Solution liquid
200.23 PYREX ring
200.24 Carbon fiber
200.25 Carbon feeder device
200.26 Carbon fiber reel
200.27 Water condensed recycle water
200.29 Top pressure seal ring
200.30 Metal pressure seal ring
200.31 Gas pipe
200.32 Arc chamber
200.33 Prior art arc-hydrolysis generator
200.34 Interior
300 Internal combustion engine
300.1 Water vapor exhaust pipe
300.2 Mechanical rotation
400 Liquefying process
401 Compressor
401.1 COH₂ liquid fuel
401.5 Compressed CO/H₂ gas
402 COH₂ liquid fuel tank
403 Heat exchanger
500 Water vapor recovery system
500.1 Hot water supply pipe
500.2 Hot water return pipe
500.3 Cold water supply pump
500.4 Coolant supply pipe
500.5 Coolant return pipe
500.6 Absorption refrigeration unit
500.7 Exhaust
500.9 Condensate tank
500.10 Hot water supply pump
500.11 Condenser coil
500.12 Internal combustion engine radiator
500.13 Condensed water supply pipe
500.14 Condensed water pump
500.15 Processed fluid output
500.16 Hot water valve/two position
500.17 Hot water heat exchanger
500.18 Hot water/steam output
500.19 Steam
600 Electrical energy source
600.3 Auxiliary DC electrical primer supply
700 Electrical generator
700.1 DC Internal generated electrical power
702 Process power output
800 Electrical power supply
800.1.1 Cold electrode terminal
800.1.2 Hot electrode terminal
800.2 Internal combustion engine DC current supply
800.3 Process auxiliary power
800.4 Fast recovery diode
800.5 Solid state pulse generator
800.6A DC battery source
800.6B DC battery source
800.7 Main switch
800.9 Voltage control module
800.10 Capacitor
800.11 Collector electrode terminal
800.12 Capacitor
800.13 Converter
800.14 First full wave rectifier
800.15 Transformer
800.16 Adjustable resistor unit
800.17 Pump Power
800.18 Second full wave rectifier
800.19A DC Relay D.P.D.T
800.19B DC Relay D.P.D.T
800.20 Diode
900 Process optimization
1000 Control system
1000.9 Electrical energy setpoint
1000.15 Reactor flow setpoint
1000.16 Reactor pressure setpoint
1000.17 Reactor temperature setpoint
1000.4 Hot circuit current transducer
1000.5 Collector circuit current transducer
1000.6 Cold circuit current transducer
1000.7 Electrical power system
1000.8 Rotational energy
1000.20 Battery charge transducer
1000.21 Liquid level transducer
1000.22 Mixed gas volume transducer
1000.23 Fresh water flow transducer gpm
1000.24 Water vapor volume transducer
1000.26 Internally generated electrical energy
1000.27 Pressure transducer
1000.28 Temperature transducer
1000.29 Biomass fluid level transducer
1000.31 Processed fluid flow transducer GPM
1000.32 Water level transducer
1000.33 Hydrocarbon content transducer
1000.34 Water level transducer
1000.1 Frequency control module
1000.2 Voltage control module
1000.3 Pulse control module
1000.10 Speed control
1000.11 Speed control
1000.12 Speed control
1000.13 Speed control
1000.14 Speed control
1000.18 Carbon fiber control
1000.19 Hot water valve output/open-closed valve 500.16
1000.25 Voltage control
1000.30 Pressure reducing valve control
1000.35 Biomass mix valve control
1000.36 Biomass mix valve control
1000.37 Alternate batteries control
1100 Alternate steam/electricity generation system
1100.1 Turbine
1100.2 Rotational energy
1100.3 Electrical generator
1100.4 Electrical energy

### DETAILED DESCRIPTION OF THE PREFERRED AND SELECTED ALTERNATIVE EMBODIMENTS

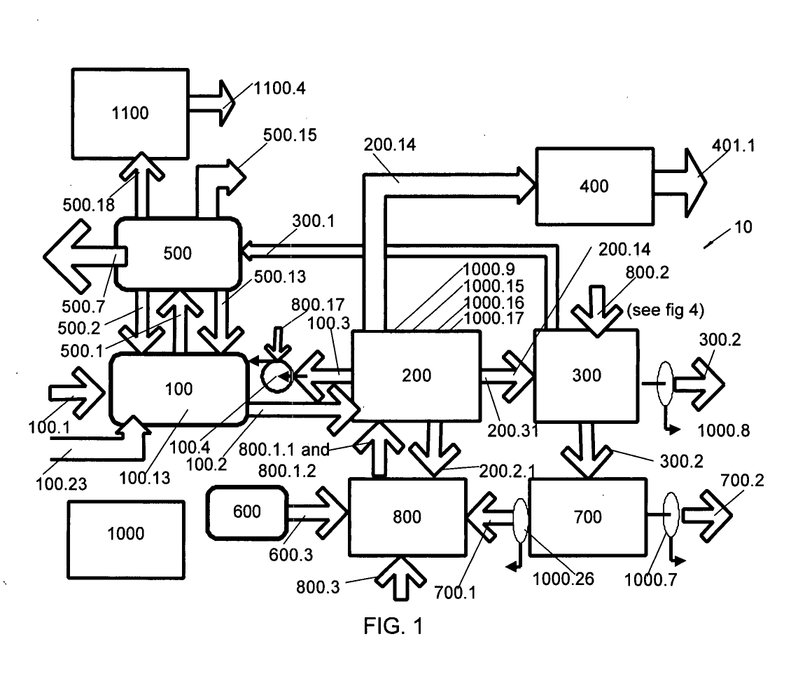

In describing the preferred and selected alternate embodiments of the present invention, as illustrated in FIGS. 1-10, specific terminology is employed for the sake of clarity. The invention, however, is not intended to be limited to the specific terminology so selected, and it is to be understood that each specific element includes all technical equivalents that operate in a similar manner to accomplish similar functions.

Referring now to FIGS. 1-2, 3B-8A and 9-10, the present invention in the preferred embodiment is arc-hydrolysis gaseous fuel generator 10 with supplemental energy recovery, preferably via formation of an arc discharge via anodes 200.4.1 and 200.5.1, wherein, preferably, anodes 200.4.1 and 200.5.1 have metal collector 200.2 disposed therearound as a means for induction, wherein metal collector 200.2 comprises, for exemplary purposes only, a grid or a coil. Energy from arc discharge electrolyzes water or biomass contained within arc-hydrolysis unit 200.1 and concurrently emits a pulse of magnetic energy.

Referring now more specifically to FIG. 1, the present invention in the preferred embodiment is arc-hydrolysis gaseous fuel generator 10 comprising supply system 100, fuel generation system 200, internal combustion engine 300, water vapor recovery system 500, electrical energy source 600, electrical generator 700, electrical power supply 800, and control system 1000. Arc-hydrolysis gaseous fuel generator 10 preferably utilizes electrical energy to power the electrical arc to ionize the fluid via electrodes, and comprises a fluid in the form of water and/or biomass, comprising hydrogen, carbon and oxygen.

Supply system 100 is preferably in fluid communication with fuel generation system 200, wherein supply system 100 preferably receives biomass liquid waste 100.13 via pipe 100.23, and wherein biomass liquid waste 100.13 flows to fuel generation system 200 via biomass supply pipe 100.2. Biomass liquid waste is preferably selectively returned to supply system 100 from fuel generation system 200 via biomass return pipe 100.3 and biomass return pump 100.4, such as during performance of maintenance on fuel generation system 200. Biomass return pump 100.4 is preferably powered by pump power supply 800.17.

Fuel generation system 200 is preferably in fluid communication with internal combustion engine 300 via fuel supply 200.14, wherein internal combustion engine 300 burns fuel at a rate selected by energy setpoint 1000.9, thereby producing rotational energy 1000.8 and rotating electrical generator 700 via mechanical rotation 300.2. Electrical current for ignition of internal combustion engine 300 is preferably supplied via direct current supply 800.2. Combustion products, including water vapor, exhaust from internal combustion engine 300 via exhaust pipe 300.1 preferably to water vapor recovery system 500.

In addition to supplying fuel for internal combustion engine 300, fuel generation system 200 preferably provides fuel for external use via external fuel line 200.14.

Fuel generation system 200 can preferably be regulated via energy setpoint 1000.9, wherein production of fuel or generation of heat energy can be selected. Heat energy selectively produced could be utilized for a variety of processes, such as, for exemplary purposes only, liquid waste processing, desalination, heating water and/or steam generation. If fuel production is desired, then energy setpoint 1000.9 is adjusted to permit fluid flow, or, alternately, setpoint 1000.9 is raised to produce higher temperature water.

Water vapor recovery system 500 is preferably in fluid communication with supply system 100 via condensed water supply pipe 500.13, hot water supply pipe 500.1 and hot water return pipe 500.2, wherein water preferably flows from supply system 100 to water vapor recovery system via hot water supply pipe 500.1 and returns via either hot water return pipe 500.2 or condensed water supply pipe 500.13. Processed fluids preferably exit water vapor recovery system 500 via processed fluid output 500.15. Exhaust gases that do not condense are preferably removed from water vapor recovery system via exhaust 500.7.

Electrical generator 700 preferably provides energy to process power output 702 and returns a portion of electrical energy produced to power supply 800 via power line 700.1, wherein power supply 800 provides energy to fuel generation system 200 via electrode terminals 800.1.1 and 800.1.2. Recovered energy is collected from direct current supply 800.2 via collector cabling 200.2.1.

Electrical energy is required for initiation operation of arc-hydrolysis gaseous fuel generator 10. Such electrical energy is preferably supplied to power supply 800 from electrical energy source 600 via supply cabling 600.3. Electrical energy source 600 provides electrical energy to power supply 800 for commencement of operation of fuel generation system 200 and/or for charging batteries 800.6A and 800.6B. Additionally, or alternately, process auxiliary power 800.3 may be utilized to provide power to electrical power supply 800.

Arc-hydrolysis gaseous fuel generator 10 further comprises control system 1000, wherein control system 1000 preferably provides control and power flow sequencing for arc-hydrolysis gaseous fuel generator 10.

Supply system 100 preferably stores and provides solution 200.22 to arc-hydrolysis reactor 200.1, wherein solution 200.22 preferably comprises water and biomass. Additionally, supply system 100 serves as a circulating cooling chamber.

Fuel generation system 200 preferably generates and mixes hydrogen-carbon monoxide gaseous fuel (CO/H₂) from arc-hydrolysis reactor 200.1 with air to provide mixed fuel 200.14 for internal combustion engine 300, wherein internal combustion engine 300 delivers mechanical rotational energy to electrical generator 700, and wherein electrical generator 700 provides electrical energy to power supply 800. Subsequently, power supply 800 provides the electrical energy required by fuel generation system 200 for production of CO/H₂.

Water vapor recovery system 500 preferably provides coolant to condense water vapor and carbon dioxide exhausted by internal combustion engine 300. The exhaust from combustion of CO/H₂ with 33% to 50% less carbon dioxide than generally utilized fossil fuels is not known to be carcinogenic.

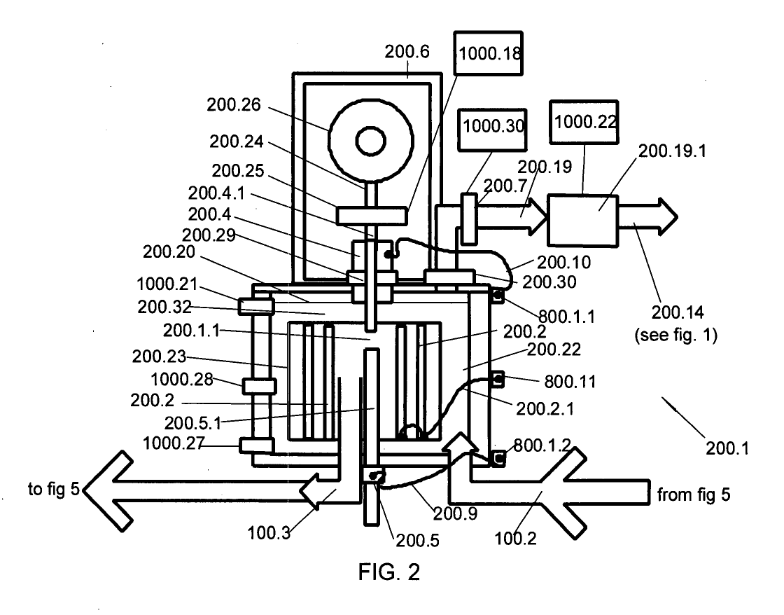

Referring now more specifically to FIG. 2, in the preferred embodiment, arc-hydrolysis reactor 200.1 comprises high voltage hot anode 200.5.1 and low voltage cold anode 200.4.1, wherein arc point 200.1.1 is disposed between high voltage hot anode 200.5.1 and low voltage cold anode 200.4.1. Arc-hydrolysis reactor 200.1 further comprises metal collector 200.2 and collector cable 200.2.1, wherein metal collector 200.2 is preferably disposed around high voltage hot anode 200.5.1, arc point 200.1.1, and low voltage cold anode 200.4.1, and wherein collector cable 200.2.1 preferably provides electrical communication between metal collector 200.2 and collector electrode terminal 800.11. Preferred low voltage cold anode 200.4.1 passes through cold electrode seal ring 200.4 and top pressure seal ring 200.29, wherein low voltage cold anode 200.4.1 preferably comprises carbon fiber 200.24, wherein carbon fiber 200.24 is preferably fed from carbon feeder reel 200.26 by carbon feeder 200.25 on demand from carbon fiber control 1000.18. Fiber feed casing 200.6 is disposed around carbon feeder reel 200.26. Hot electrode seal ring 200.5 is preferably in electrical communication with hot electrode terminal 800.1.2 via hot electrode cable 200.9, wherein cable 200.9 should preferably be able to carry high current of approximately 20 amps.

Arc chamber 200.32 preferably comprises PYREX ring 200.23, liquid level 200.20, metal pressure seal ring 200.30, solution 200.22, bottom pressure seal ring 200.4, wherein bottom pressure seal ring 200.4 is preferably in electrical communication with cold electrode terminal 800.1.1 via cold electrode cable 200.10, wherein cable 200.10 should preferably be able to carry high current of approximately 20 amps. Arc chamber 200.31 further preferably comprises liquid level transducer 1000.21, pressure transducer 1000.27, and temperature transducer 1000.28, wherein transducers 1000.21, 1000.27 and 1000.28 are preferably in communication with pressure reducing valve control 1000.30. Arc chamber 200.32 is preferably fed with biomass via biomass supply pipe 100.2 and excess biomass is preferably returned to supply system 100 via biomass return pipe 100.3.

Fuel/air mixer 200.19.1 preferably collects CO/H₂ produced by arc-hydrolysis reactor 200.1 for subsequent feeding to internal combustion engine 300. In the preferred embodiment, pressure reducing valve. 200.7 selectively controls pressure in arc chamber 200.32 thereby permitting fuel to flow to gaseous fuel collector 200.19, wherein mixed gas volume transducer 1000.22 controls volume of mixed fuel 200.14 preferably in fuel/air mixer 200.19.1, wherein mixed fuel 200.14 comprises carbon monoxide and hydrogen (CO/H₂). CO/H₂ is preferably mixed with eight parts of air by fuel/air mixer 200.19.1.

Arc-hydrolysis reactor 200.1 preferably comprises any magnetically inert material, such as, for exemplary purposes only, ceramic material. PYREX ring 200.23 is preferably provided as a component of arc-hydrolysis reactor 200.1, wherein PYREX ring 200.23 is formed from borosilicate glass, or other non-magnetic material that can withstand high temperatures, and wherein PYREX ring 200.23 preferably functions to protect metal collector 200.2 from potential corrosion and abrasive action of solution 200.22. Metal collector 200.2 is preferably copper, or other highly conductive material, formed into one or several copper rings preferably embedded within PYREX ring 200.23. In the preferred form, metal collector 200.2 acts as an electromagnetic antenna and collects radiated magnetic energy formed by the collapse of the high current spark discharge at arc point 200.1.1.

During the preferred use, arc-hydrolysis reactor 200.1 preferably contains carbon-rich solution 200.22. A spark is generated in arc chamber 200.32 at arc point 200.1.1, between high voltage hot anode 200.5.1 and low voltage cold anode 200.4.1, wherein low voltage cold anode 200.4.1 preferably includes carbon fiber 200.24. Biomass container tank 100.5 (best shown in FIG.. 5) feeds additional biomass, preferably in liquid form, via biomass supply pipe 100.2, thereby providing a source of carbon to solution 200.22, in addition to carbon fiber 200.24 utilized by arc-hydrolysis reactor 200.1. Biomass supply pipe 100.2 and biomass return pipe 100.3 further provide circulation for cooling solution 200.22.

Arc-hydrolysis reactor 200.1 preferably includes two seal rings, top pressure seal ring 200.4 and hot electrode seal ring 200.5, wherein rings 200.4 and 200.5 sealedly retain low voltage cold anode 200.4.1 and high voltage anode 200.5.1, respectively. Preferably, high voltage hot anode 200.5.1 is fixedly-retained in seal ring 200.5 and comprises tungsten, or similar durable electrode material. Low voltage cold anode 200.4.1 preferably comprises carbon fiber 200.24, wherein carbon fiber 200.24 is preferably fed by fiber feeder 200.25 as required from carbon fiber reel 200.26.

Anodes 200.5.1 and 200.4.1 are preferably coaxially-aligned, wherein arc point 200.1.1 is formed therebetween, with a maximum effective electrical arc achieved when the dimensions of arc point 200.1.1 are a few tenths of an inch. The spark, or arc, is produced by high current pulse discharge flowing from high current hot anode 200.5.1 to low voltage anode 200.4.1. The optimal gap distance is selected by carbon fiber control 1000.18 via carbon feeder 200.25, wherein carbon fiber control 1000.18 responds to signals from transducers 1000.4, 1000.5 and 1000.6.

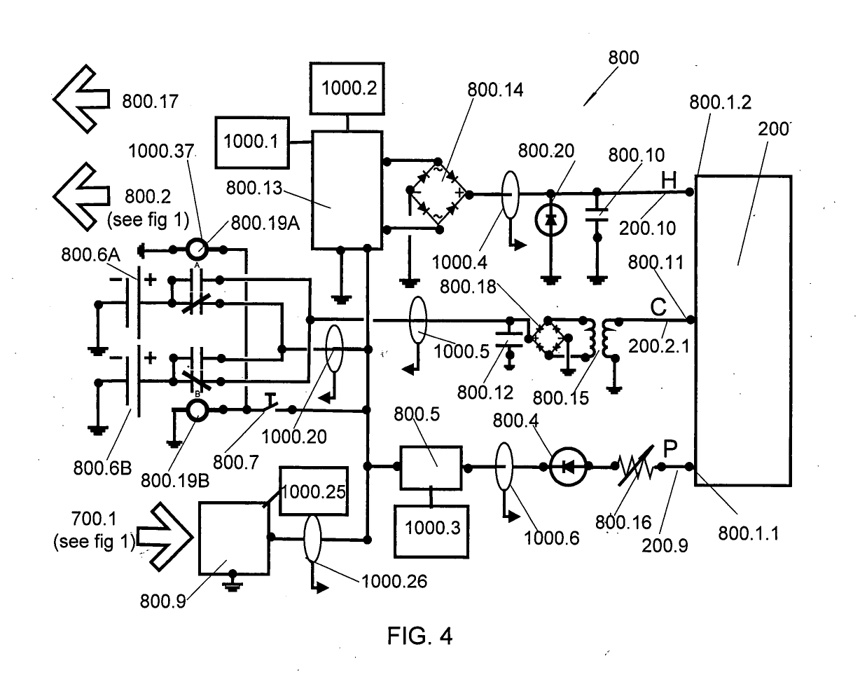

Ionization of water and biomass takes place at arc point 200.1.1. In the preferred embodiment, carbon feeder 200.25 automatically feeds carbon fiber 200.24 to maintain the preferred gap distance by controlling cabon feeder 200.25 to optimize the level of gas production relative to electrical power generation as sensed via hot circuit current transducer 1000.4, collector circuit current transducer 1000.5 and cold circuit current transducer 1000.6 (best shown in FIG. 4). High current hot anode 200.5.1 is preferably controlled in or out by carbon feeder 200.25 to maintain the selected energy of arc discharge.

Terminals 800.1.1 and 800.1.2 deliver electrical energy to produce a high current arc and metal collector 200.2 preferably collects and stores energy formed by the arc discharge and by the magnetic field formed from the collapse of the arc discharge at arc point 200.1.1. As previously discussed, metal collector 200.2 comprises metal cylindrical ring forms preferably made out of copper imbedded in PYREX ring 200.23, wherein PYREX ring 200.23 is preferably disposed within arc-hydrolysis reactor 200.1 proximate arc point 200.1.1.

Metal collector 200.2 preferably collects the magnetic field energy after collapse of the magnetic field, wherein the energy collected is preferably utilized to re-charge batteries 800.6A and 800.6B. Collection and reuse of this energy increases the electrical efficiency of the present invention, preferably collecting between 50 to 60% of the electrical energy utilized by the spark at arc point 200.1.1. PYREX ring 200.23, with metal collector 200.2, is preferably disposed around and proximate arc point 200.1.1, wherein metal collector 200.2 is in electrical communication with collector cable 200.2.1 via collector electrode terminal 800.11, and wherein collector electrode terminal 800.11 delivers electrical energy to batteries 800.6A and 800.6B for storage.

In the preferred embodiment, arc-hydrolysis reactor 200.1 also includes temperature transducer 1000.28 and pressure transducer 1000.27, wherein temperature transducer 1000.28 and pressure transducer 1000.27 monitor and control temperature and pressure, respectively, within arc-hydrolysis reactor 200.1 via control system 1000. The fluid level in arc-hydrolysis reactor 200.1 is monitored via liquid level transducer 1000.21.

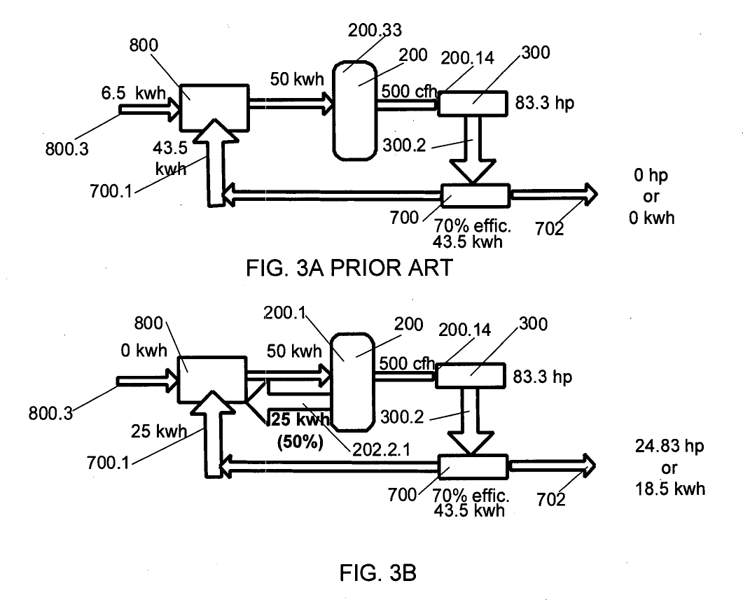

Referring now more specifically to FIG. 3A, depicted therein is energy flow and efficiency diagrammed for a prior art gaseous fuel generator, wherein production of CO/H₂ is approximately 500 cubic feet per hour per 50 Kilowatt-hour, and wherein a 100 horsepower internal combustion engine 300 would require 600 cubic feet per hour (cfh) of CO/H₂ to produce 100 Horsepower (74.57 kWh) of mechanical energy. Factoring in generally-accepted energy efficiencies of mechanical conversion to electrical energy via a generator, prior art arc-hydrolysis reactor 200.33 has a conversion efficiency of only 87.0%. Accordingly, utilizing such prior art device and process, prior-art arc-hydrolysis reactor 200.33 would run a deficit of about 6.5 kWh continuously for 50 kWh throughput.

Thus, 50 kWh power input to prior art arc-hydrolysis reactor unit 200.33 would produce 500 cfh of mixed fuel 200.14, wherein internal combustion engine 300 would produce 83.3 HP (or 62.16 kWh) of mechanical rotation 300.2 therefrom. Connection of internal combustion engine 300 to electrical generator 700 would deliver 43.5 kWh to power line 700.1, resulting in 70% efficiency. This is a deficit of 6.5 kWh and would require 6.5 kWh of added electrical power to continue to provide 50 kWh throughput.

On the other hand, FIG. 3B demonstrates that, with the present invention, like the prior art, 50 kWh power into arc-hydrolysis reactor 200.1 produces 500 cfh of mixed fuel 200.14 wherein combusting same in internal combustion engine 300 produces 83.3 HP of mechanical rotation 300.2 producing 43.5 kWh of generated power to power line 700.1 via electrical generator 700. However, in the preferred embodiment of the present invention, with collection of energy from the magnetic field created by the arc discharge, and collapse thereof, via metal collector 202.2 approximately up to 25 kWh for recovery and storage in batteries 800.6A and 800.6B is provided. Thus, minimal outside power is required to produce mixed fuel 200.14, as compared to prior art systems.

Referring now more specifically to FIG. 4, hot electrode terminal 800.1.2 of power supply 800 is preferably in electrical communication with grounded capacitor 800.10, hot circuit current transducer 1000.4 and first full wave rectifier 800.14. First full wave rectifier 800.14 preferably supplies direct current to converter 800.13, wherein converter 800.13 is controlled by frequency control module 1000.1 and voltage control module 1000.2, wherein converter 800.13 converts low voltage direct current pulses into high voltage pulses. The frequency of converter 800.13 is selected to control the frequency of pulses from solid state pulse generator 800.5, thereby to maintain a high potential across capacitor 800.10.

Preferably converter 800.13 is in electrical communication with battery charge transducer 1000.20, main switch 800.7, first double pole, double throw (DPDT) relay 800.19A, second DPDT relay 800.19B, first battery 800.6A, and second battery 800.6B. Converter 800.13 is preferably also in electrical communication with solid state pulse generator 800.5 and with voltage control module 800.9, wherein voltage control module 800.9 is controlled by voltage control 1000.25 and wherein voltage control module 800.9 is fed by power line 700.1. Voltage control module 800.9 preferably provides information to control system 1000 to adjust the gap at arc point 200.1.1. Solid state pulse generator 800.5 is preferably controlled by pulse control module 1000.3.

In the preferred embodiment, collector electrode terminal 800.11 is in electrical communication with transformer 800.15, and transformer 800.15 is in electrical communication with second full wave rectifier 800.18, wherein second full wave rectifier 800.18 is grounded through capacitor 800.12. Capacitor 800.12 is, preferably rated at 12 μF and 5 kVA; however, other ratings and/or capacitors could be alternately utilized.

Second full wave rectifier 800.18 is preferably in electrical communication with collector circuit current transducer 1000.5, wherein collector circuit current transducer 1000.5 is in electrical communication with first battery 800.6A and second battery 800.6B, thereby providing pulsed DC current to batteries 800.6A and 800.6B.

In the preferred configuration, cold electrode terminal 80.0.1.1 is in electrical communication with variable resistor 800.16, wherein variable resistor 800.16 is in further electrical communication with fast recovery diode 800.4, and wherein variable resistor 800.16 provides control and protection against excessive energy draw from batteries 800.6A and 800.6B. Fast recovery diode 800.4 is preferably in electrical communication with solid state pulse generator 800.5, and is preferably controlled via cold circuit current transducer 1000.6.

The preferred electrical circuitry for providing arc discharges and for recovering energy therefrom can be divided into three main circuits:

1) Circuit H provides the requisite high direct current power, (preferably approximately 5 kVA) to high voltage hot anode 200.5.1. Circuit H provides power, preferably direct current power from batteries 800.6A and 800.6B, via converter 800.13, wherein converter 800.13 raises the voltage supplied to first full wave rectifier 800.14. First full wave rectifier 800.14 provides output to high voltage hot anode 200.5.1, grounded through high current diode 800.20 and capacitor 800.10, wherein capacitor 800.10 is sequentially charged and discharged to provide pulses to high voltage hot anode 200.5.1.

High voltage hot anode 200.5.1 provides about 3000 volts, at 20 amps or greater, depending on desired power output across anodes 200.4.1 and 200.5.1, creating an arc discharge at arc point 200.1.1. Pulsed energy from low voltage cold anode 200.4.1 forms an arc plasma for ionization of solution 200.22 and a clearly visible light.

2) Circuit P Provides low voltage pulses required by low voltage cold anode 200.4.1 for initiating the arc discharge. Pulses are preferably provided by solid state pulse generator 800.5 via fast recovery diode 800.4. Fast recovery diode 800.4 acts as a barrier to prevent high energy arcing back to solid state pulse generator 800.5. Solid state pulse generator 800.5 preferably provides an adjustable pulse of about 12 volts, 20 amps or greater, for approximately 0.00005 to 0.01 second pulse durations with an equally adjustable off time proportional to the maximum optimal ration of ionization rate versus the recycling rate of electrical energy.

3) Circuit C includes metal collector 200.2, wherein metal collector 200.2 captures the short duration electromagnetic pulsating energy field of the magnetic plasma as the plasma is repeated radiated and the magnetic field repeatedly collapses after the arc has ceased to exist. Electrical energy is collected by metal collector 200.2 around arc point 200.1.1, and anodes 200.4.1 and 200.5.1, wherein the energy then travels to transformer 800.15 and subsequently to second full wave rectifier 800.18, thereby charging batteries 800.6A and 800.6B, and wherein the energy is filtered by capacitor 800.12.

Batteries 800.6A and 800.6B are preferably deep cycle battery types, rated at 12 volts and 200 Ampere-hours, wherein batteries 800.6A and 800.6B preferably deliver a steady 10 Amperes for at least 5 hours.

Batteries 800.6A and 800.6B preferably provide direct current power via current supply 800.2 to internal combustion engine 300. Power supply 800.17 preferably provides power for biomass return pump 100.4 and biomass supply pump 100.12. Main switch 800.7 disconnects batteries 800.6A and 800.6B from all the circuits. A plurality of batteries are utilized to enable selective output and collection of the energy, wherein batteries 800.6A and 800.6B are preferably alternately charged and discharged.

Once an electrical arc has been started in arc-hydrolysis reactor 200.1, and is maintained, water in solution 200.23 preferably becomes super-conducting, wherein the resistance of water collapses to very low impedance and the volume of gas produced is directly proportional to the size of the arc between anodes 200.4.1 and 200.5.1, and proportional to the quantity of fluid pumped through arc-hydrolysis reactor 200.1. (Unlike electric arc discharges in air, the gap of the arc within a liquid can be increased in length utilizing an increase in the electric current.)

The faster the flow of fluid through arc-hydrolysis reactor 200.1, the larger the arc produced therein, and the greater the volume of gas produced. Therefore, by increasing fluid flow and current flow, the volume of gas produced is increased. The size of the arc and the amount of current is preferably controlled by controlling the pulse of solid state pulse controller 800.5 via pulse control module 1000.3. Frequency and voltage control of converter 800.13 is preferably achieved via frequency control module 1000.1 and voltage control module 1000.2. Because the strength of the electric arc is so important for the process, the arc efficiency is preferably monitored via collector circuit current transducer 1000.5. Collector circuit current transducer 1000.5 provides controller 1000 with information regarding the strength of the arc, and wherein controller 1000 preferably optimizes conditions for the largest arc at arc point 200.1.1 by feeding carbon fiber 200.25.

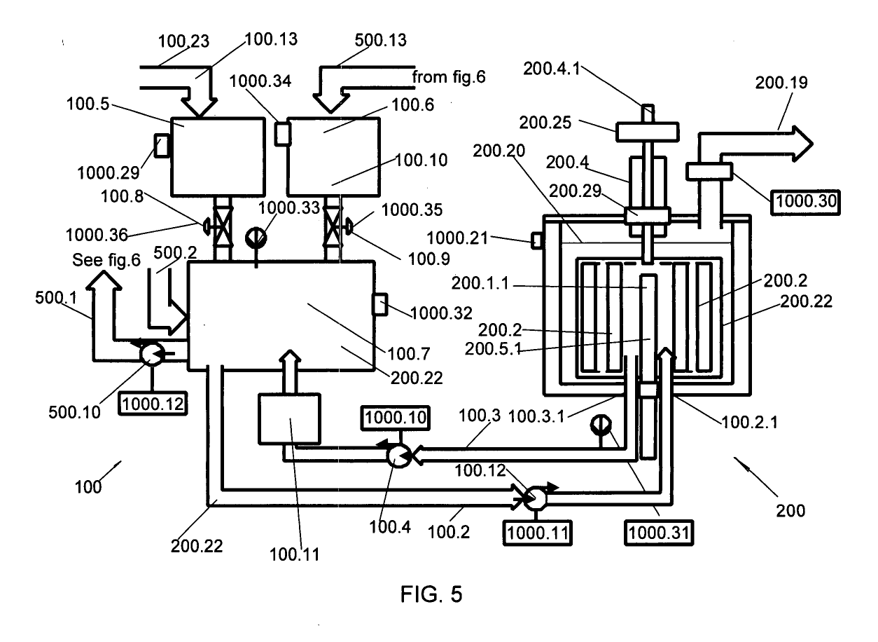

Referring now more specifically to FIG. 5, arc-hydrolysis reactor 200.1 is preferably in fluid communication with electrolyte recirculation tank 100.7 via biomass supply outlet 100.3.1, wherein biomass supply outlet 100.3.1 is in fluid communication with biomass return pipe 100.3, and via biomass supply inlet 100.2.1, wherein biomass supply inlet 100.2.1 is in fluid communication with biomass supply pipe 100.2. Preferably, biomass liquid is pumped from electrolyte recirculation tank 100.7 through biomass supply pipe 100.2 via biomass supply pump 100.12 in response to speed control 1000.11.

Biomass preferably returns to electrolyte recirculation tank 100.7 from arc-hydrolysis reactor 200.1 via biomass return pipe 100.3 and solid trap tank 100.11, wherein biomass is pumped via biomass return pump 100.4, as controlled by speed control 1000.10.

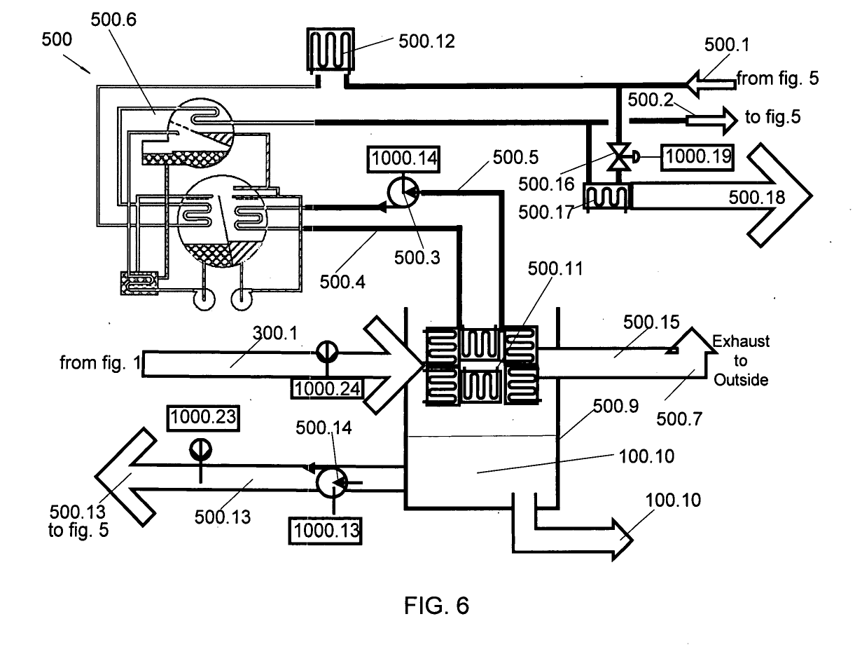

Electrolyte recirculation tank 100.7 preferably comprises hydrocarbon content transducer 1000.33 and water level transducer 1000 32. Preferably, electrolyte recirculation tank 100.7 receives hot water from absorption refrigeration unit 500.6 (see FIG. 6) via hot water return pipe 500.2 and sends hot water to absorption refrigeration unit 500.6 via hot water supply pipe 500.1 through hot water supply pump 500.10, wherein hot water supply pump 500.10 is controlled by speed control 1000.12.

Electrolyte recirculation tank 100.7 is supplied, via water supply valve 100.9, with water from water supply tank 100.6, containing recycled water 100.10, wherein water supply valve 100.9 is controlled by first biomass mix valve control 1000.35. Electrolyte recirculation tank 100.7 is also preferably supplied with biomass from biomass container tank 100.5, via biomass supply valve 100.8, wherein biomass supply valve 100.8 is controlled by second biomass mix valve control 1000.36.

Biomass container tank 100.5 preferably receives biomass liquid waste 100.23, wherein volume in biomass container tank 100.5 is monitored and controlled by biomass fluid level transducer 1000.29. Water supply tank 100.6 preferably receives water from condensed water supply pipe 500.13, wherein volume in water supply tank 100.6 is monitored and controlled by water level transducer 1000.34.

Referring now more particularly to FIG. 5, depicted therein is preferred supply system 100 and fuel generation system 200, wherein supply system 100 preferably recirculates solution 200.22 through arc-hydrolysis reactor 200.1.

Arc-hydrolysis reactor 200.1 preferably operates at a very high temperature (5000 to 6000 degrees Fahrenheit). For a standard 50 KWh arc-hydrolysis gaseous fuel generator 10, about 250,000 BTU/hour or 4,166 BTU/min (500 BTU per cubic foot for 500 hours) are dissipated or removed; otherwise, the process will generate excessive heat. Supply system 100 and water vapor recovery system 500 preferably function to keep arc-hydrolysis reactor 200.1 provided with solution 200.22 and to carry excess heat away to absorption refrigeration unit 500.6 for use in recycling water. That is, the heat is preferably utilized to power the refrigeration process at absorption refrigeration unit 500.6 to produce a coolant medium that is used at the condenser coil 500.11.

For a 50 kWh arc-hydrolysis gaseous fuel generator 10, about 80 to 90% of the water utilized by prior-art apparatuses and methods will be required to replenish converted solution 200.22, wherein solution 200.22 is converted into CO/H₂, and solution 200.22 must be recirculated to maintain the temperature of the solution 200.22 in arc-hydrolysis reactor 200.1 (approximately 300 to 400 degrees Fahrenheit) for efficient operation.

Similarly, pumps 100.4, and 100.12 and pipes 100.2 and 100.3, respectively, can be designed and sized by one skilled in the art to facilitate the desired output capacity and cooling requirements.

Supply system 100 comprises three principal components: Pumps 100.4 and 100.12, and pipes 100.2 and 100.3, wherein pump 100.4 preferably circulates solution 200.22 in order to provide cooling of heat generated in arc-hydrolysis reactor 200.1. Solution 200.22 is preferably circulated continuously from electrolyte recirculation tank 100.7 utilizing biomass supply pipe 100.2 via biomass supply inlet 100.2.1 into arc-hydrolysis reactor 200.1 and from arc-hydrolysis reactor 200.1 via biomass supply outlet 100.3.1 utilizing biomass return pipe 100.3 through pump 100.4 back to electrolyte recirculating tank 100.7.

Water supply tank 100.6 preferably provides water to electrolyte recirculation tank 100.7 providing water as required to solution 200.22. Water level transducer 1000.34 preferably controls water supply valve 100.9 to supply water to electrolyte recirculation tank 100.7.

Biomass container tank 100.5 contains solution 200.22 wherein solution 200.22 preferably comprises starches, carbohydrates, alcohol, molasses, sugars, and/or other appropriate materials, in liquid form wherein solution 200.22 comprises contain carbonaceous material in a dissolved state. Hydrocarbon content transducer 1000.33 controls biomass supply valve 100.8 to supply solution to electrolyte recirculation tank 100.7 in the proper ratio of biomass solution to water optimized for arc-hydrolysis gaseous fuel generator 10.

The quantity of solution and the rate of flow of solution 200.22 through the arc-hydrolysis reactor 200.1 are controlled by pump 100.4 according to the parameters of the pressure setpoint as described hereinbelow. The faster the flow of fluid through arc point 200.1.1, the bigger the volume of CO/H₂ produced; therefore, by increasing the flow of solution 200.22 and increasing current, the volume of CO/H₂ is be increased.

Pressure for a particular application can be adjusted preferably between atmospheric pressure to 200 psi, depending on the amount of heat required, wherein the higher the pressure, the higher the amount of heat generated. Preferably modulating of the speed of pumps 100.4 and 100.12, and varying the pressure setpoint via pressure reducing valve control 1000.30, controls the pressure inside arc-hydrolysis reactor 200.1. Pressure transducer 1000.27 preferably reads the pressure in the arc-hydrolysis reactor and communicates same with controller 1000.

Referring now more specifically to FIG. 6, depicted therein is preferred water vapor recovery system 500, including absorption refrigeration unit 500.6, condensate tank 500.9, condenser coil 500.11 and radiator 500.12 of internal combustion engine 300. Absorption refrigeration unit 500.6 is in fluid communication with condenser coil 500.11 preferably via cold water supply pipe 500.3 and coolant return pipe 500.5, wherein coolant return pipe 500.5 includes cold water supply pump 500.3, and wherein cold water supply pump 500.3 is controlled by speed control 1000.14.

Heat is preferably derived from internal combustion engine 300 via exhaust pipe 300.1, wherein exhaust flows over condenser coil 500.11 as dictated by water vapor volume transducer 1000.24.

Radiator 500.12 is in fluid communication with hot water/steam output 500.18 preferably via hot water valve 500.16, hot water return pipe 500.2, wherein hot water return pipe 500.2 is in fluid communication with supply system 100, and hot water supply pipe 500.1, wherein hot water valve 500.16 is preferably controlled by hot water valve control 1000.19.

Condensate tank 500.9 preferably contains recycled water 100.10 and is in fluid communication with water supply tank 100.6 (best shown in FIG. 5) via condensed water supply pipe 500.13 and condensed water pump 500.14, wherein condensed water pump 500.14 is controlled by speed control 1000.13. Fresh water flow rate transducer 1000.23 preferably controls the quantity of water supplied to water supply tank 100.6.

Referring now more specifically to FIG. 6, illustrated therein is water vapor recovery system 500, wherein water vapor recovery system 500 preferably serves two principal functions: a) Heat generated by arc-hydrolysis reactor 200.1 is preferably utilized to power absorption refrigeration unit 500.6 utilizing hot water pipes 500.1 and 500.2, wherein hot water pipes 500.1 and 500.2, supply and return hot water from electrolyte recirculation tank 100.7, and, b) water vapor produced by internal combustion engine 300 is preferably recycled into water by condensation. Water vapor exhaust pipe 300.1 preferably delivers water vapor exhausted from internal combustion engine 300 to absorption refrigeration unit 500.6.

Absorption refrigeration unit 500.6 delivers the hot water, received via hot water supply pipe 500.1 and exchanged at heat exchanger 500.17, to condenser coil 500.11 via coolant supply pipe 500.4 and coolant return pipe 500.5. Exhaust exiting via internal combustion engine exhaust pipe 300.1 comprises water vapor and carbon dioxide. Exhaust preferably passes through condenser coil 500.11 wherein water vapor is condensed into water and collected to condensate tank 500.9. Condensed water is subsequently preferably collected in condensate tank 500.9 and returned to water supply tank 100.6 via condensed water supply pipe 500.13, thereby recirculating and replenishing the water required by arc-hydrolysis reactor 200.1.

Utilizing the the present invention, CO/H₂ production for a standard 50 Kwh unit is about 500 cubic feet per hour, wherein each volume part of CO/H₂ is mixed with eight parts of fresh air for proper combustion. Water recovered via condensation includes the water content of the volume of CO/H₂ combusted and the humidity content of the fresh air utilized, for a potential volume of approximately 4500 cubit feet per hour of water. Thus, condensed atmospheric moisture can provide the water required by arc-hydrolysis gaseous fuel generator 10. Thus, excess water can be reclaimed for non-process uses via tank 500.9.

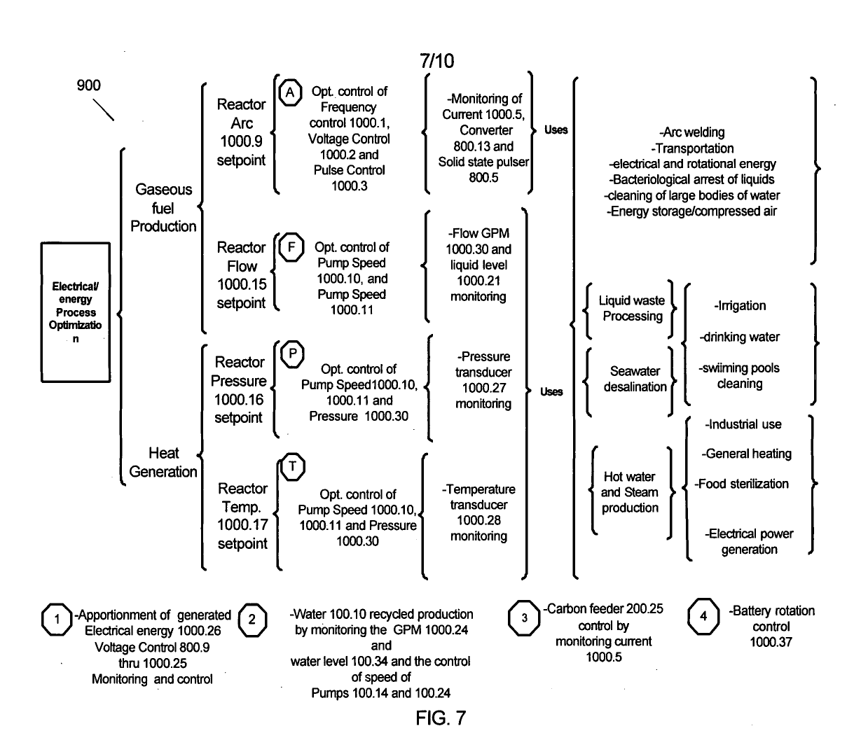

Referring now more specifically to FIG. 7, depicted therein is preferred electrical/rotational energy process optimization 900 of arc-hydrolysis gaseous fuel generator 10, wherein process optimization 900 of arc-hydrolysis gaseous fuel generator 10 provides for the selection of a variety of optimization strategies, A, F, P, and T, as set forth hereinbelow, for the optimization of various parameters the process, respectively, and further provides for critical maintenance optimization strategies 1, 2, 3, and 4, wherein critical maintenance optimization strategies 1, 2, 3, and 4 define ancillary processes necessary to facilitate continuous process operation.

Optimization Strategy A

The flow of the high current electricity to produce the arc in arc-hydrolysis reactor 200.1 is preferably controlled by frequency control module 1000.1, and voltage control module 1000.2 of converter 800.13, and pulse control module 1000.3. Preferably, the size of the pulse is controlled by solid state pulse generator 800.5, as controlled by pulse control module 1000.3, and by collector circuit current transducer 1000.5, wherein collector circuit current transducer 1000.5 monitors the current and indicates the amount of energy being collected by metal collector 200.2. The length of the pulse is extremely important with the preferred pulse in the range of thousandths of a second. Particularly, solid state pulse generator 800.5 is preferably selectively-adjustable to a duration of 0.00005 to 0.01 seconds and equally adjustable off time proportional to the maximum optimal ration of ionization/hydrolysis versus recycling rate of electrical energy.

Collector circuit current transducer 1000.5 provides control system 1000 with information about the strength of the arc and preferably optimizes conditions to provide the largest possible arc at arc point 200.1.1 by feeding carbon fiber 200.25 via carbon fiber control 1000.18 to maintain the critical, or maximum, arc.

Optimization Strategy F

The faster the flow of fluid and the larger the volume of fluid through arc point 200.1.1, the bigger the volume provided to gaseous fuel collector 200.19. The volume into gaseous fuel collector 200.19 is thus preferably directly proportional to the size of the arc between low voltage cold anode 200.4.1 and high voltage hot anode 200.5.1, and to the amount of solution 200.22 pumped through arc-hydrolysis reactor 200.1.

The flow of fluid is preferably optimized via control of the speed of biomass return pump 100.4 and biomass supply pump 100.12 via speed controls 1000.10 and 1000.11, respectively. The actual gallons per minute (GPM) of flow is preferably monitored via processed fluid flow transducer 1000.31, wherein processed fluid flow transducer 1000.31 controls to reactor flow setpoint 1000.15.

Optimization Strategy P

Pressure indirectly effects heat generated by the process, wherein the higher the pressure, the higher the temperature that is generated. Pressure for a particular application can preferably be adjusted, preferably between 20 psi and 200 psi, depending on the amount of heat required. Pressure is preferably controlled by biomass supply pump 100.12 and pressure reducing valve 200.7, wherein biomass supply pump 100.12 is controlled by speed control 1000.11 and pressure reducing valve 200.7 is controlled by pressure reducing valve control 1000.30. The actual pressure in arc-hydrolysis reactor 200.1 is preferably monitored by pressure transducer 1000.27, wherein pressure transducer 1000.27 controls to reactor pressure setpoint 1000.16..

Optimization Strategy T

Temperature can be critical for certain processes that require high heat. If the process is specifically designed to generate maximum heat, parameters including temperature, pressure and flow should preferably be controlled concurrently to maximize the amount of heat generated, wherein flow is preferably monitored via processed fluid transducer 1000.31, pressure via pressure transducer 1000.27, and temperature via collector circuit current transducer 1000.5 and via temperature transducer 1000.28. Control is preferably achieved by biomass supply pump 100.12, wherein biomass supply pump 100.12 is preferably controlled via speed control 1000.11 and via pressure reducing valve 200.7, preferably in response to reactor temperature setpoint 1000.17.

There are four (4) preferred ancillary processes that enable preferred maximization and optimization of arc-hydrolysis gaseous fuel generator 10, depending on whether the application is for electrical or rotational energy, or for heat production. These are:

1) Apportionment of generated electrical energy within arc-hydrolysis gaseous fuel generator 10 by controlling voltage control module 800.9 via voltage control 1000.25 can be utilized to optimize charging of batteries 800.6A and 800.6B during idling periods, wherein high electrical energy for electrical power system 1000.7 is not required.

For applications specifically dedicated to generation of maximum electrical energy, internally generated electrical energy 1000.26 is preferably equivalent to at least the minimum amount of recharge energy necessary for batteries 800.6A and 800.6B. Such a level of internally generated electrical energy 1000.26 maximizes the output of electrical power system 1000.7.

For applications with a goal of generation of maximum heat, internally generated electrical energy 1000.26 is preferably set to maximize energy to the arc at arc point 200.1.1 in order to generate the maximum quantity of fuel and/or to generate any desired quantity of hot water.

2) Optimization of recycled water supply 100.10 is preferably accomplished via speed control 1000.14 and water vapor volume transducer 1000.24, and via utilization of the maximum heat generated by arc-hydrolysis reactor 200.1.

3) Carbon is preferably available to the process from two sources, first, from low voltage cold anode 200.4.1, preferably made out of carbon fiber 200.24 provided via carbon feeder 200.25, and second, from biomass container tank 100.5, wherein biomass container tank 100.5 contains carbon-containing biomass liquid waste 100.13. During feeding of carbon fiber 200.24 through carbon feeder 200.25, the quality of the arc at arc point 200.1.1 is preferably monitored via collector current transducer 1000.5, wherein collector current transducer 1000.5 indicates the amount of energy being collected.

4) Preferably, batteries 800.6A and 800.6B are alternately switched in and out, to permit use of one while the other is being recharged, via alternating battery control 1000.37 (best shown in FIG. 4), as selected by battery charge transducer 1000.20.

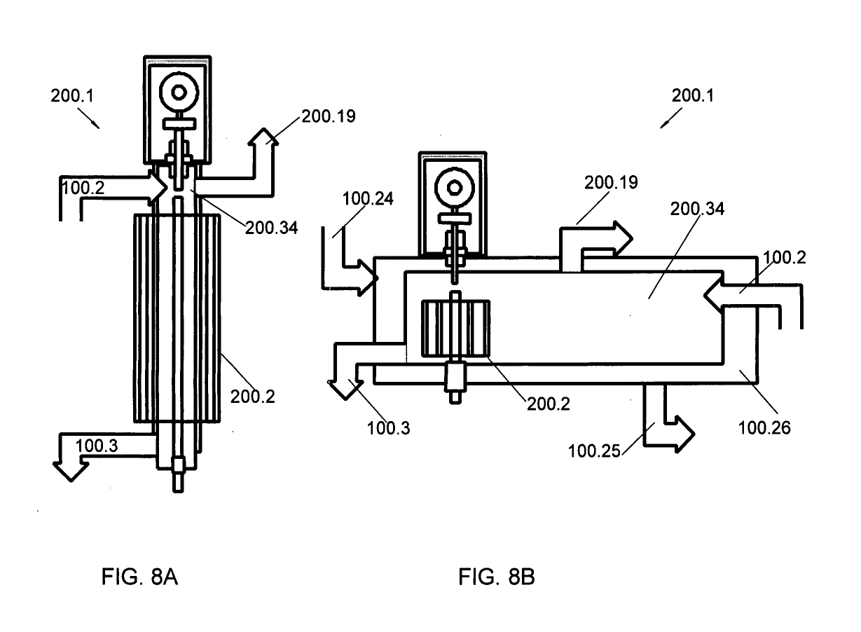

Referring now more particularly to FIG. 8A, depicted therein is interior 200.34 of arc-hydrolysis reactor 200.1, wherein biomass supply pipe 100.2 is preferably in fluid communication with interior 200.34 to permit flow of biomass through arc-hydrolysis reactor 200.1. To facilitate recirculation, biomass preferably exits interior 200.34 via biomass return pipe 100.3, returning to electrolyte recirculation tank 100.7 (best shown in FIG. 5).

The advantageous configuration of FIG. 8A reduces and/or eliminates corrosion of metal collector 200.2, wherein metal collector 200.1.2 is outside arc-hydrolysis reactor 200.1, and wherein metal collector 200.2 is sufficiently near arc point 200.1.1 to receive electromagnetic energy therefrom via induction.

Referring now more particularly to FIG. 8B, illustrated therein is an alternate embodiment of arc-hydrolysis gaseous fuel generator 10, wherein the alternate embodiment of FIG. 8B is substantially equivalent in form and function to that of the preferred embodiment detailed and illustrated in FIGS. 1-2 and 3B-8A except as hereinafter specifically referenced. Specifically, the embodiment of FIG. 8B comprises arc-hydrolysis reactor 200.1 having optional water jacket 100.26, wherein water jacket 100.26 comprises cooling water inlet 100.24 and cooling water outlet 100.25. Water from water supply tank 100.6 (best shown in FIG. 5) is recirculated through arc-hydrolysis reactor 200.1 to provide cooling thereof, thereby permitting further recovery and transport of heat energy via water 100.27.

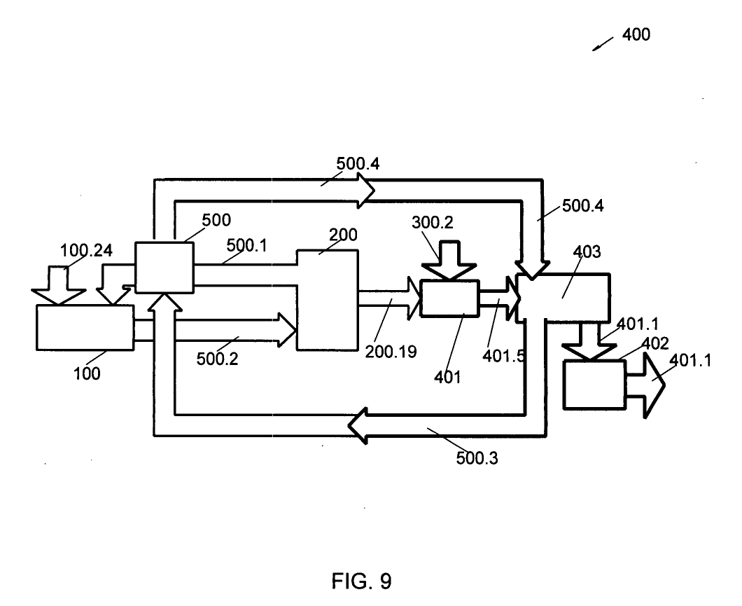

Referring now more particularly to FIG. 9, illustrated therein is an alternate embodiment of arc-hydrolysis gaseous fuel generator 10, wherein the alternate embodiment of FIG. 9 is substantially equivalent in form and function to that of the preferred embodiment detailed and illustrated in FIGS. 1-2 and 3B-BA except as hereinafter specifically referenced. Specifically, the embodiment of FIG. 9 (see also FIG. 1) comprises liquefying system 400, wherein liquefying system 400 comprises supply system 100, fuel generation system 200, water vapor recovery system 500, compressor 401, heat exchanger 403 and liquid fuel tank 402.

Pressure and/or low temperature are concurrently available in the form of mechanical rotation 300.2 to power compressor 401 to compress the gas and coolant required to cool the gas fuel to condensation. Process 400 utilizes pressure and temperature to liquefy gas fuel 200.14, forming liquid CO/H₂ 401.1. In addition to mechanical rotation 300.2, compressor 401 could be also driven equally directly by the electrical energy 702 produced by system 700.

Liquefying of mixed fuel 200.14 is thus obtained by compressing via compressor 401 utilizing mechanical rotation 300.2 forming compressed CO/H₂ gas 401.5, wherein compressed CO/H₂ gas 401.5 is subsequently passed through heat exchanger 403 condensing compressed CO/H₂ gas 401.5 into liquid fuel 401.1, and wherein liquid fuel 401.1 is subsequently stored in liquid fuel tank 402 for later use.

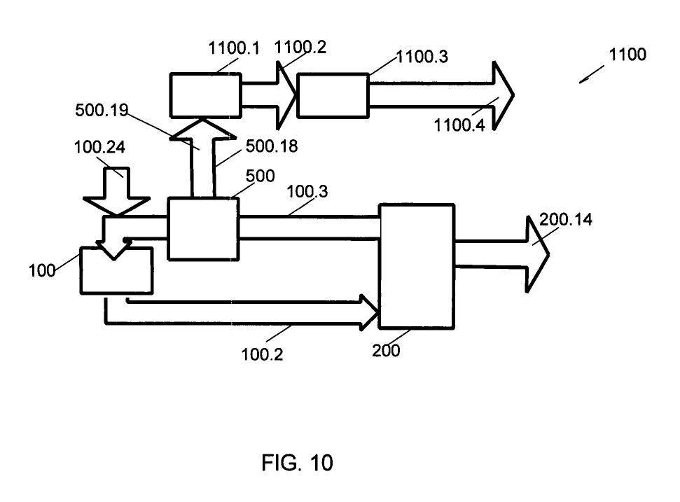

Referring now more particularly to FIG. 10, illustrated therein is an alternate embodiment of arc-hydrolysis gaseous fuel generator 10, wherein the alternate embodiment of FIG. 10 is substantially equivalent in form and function to that of the preferred embodiment detailed and illustrated in FIGS. 1-2 and 3B-8A except as hereinafter specifically referenced. Specifically, the embodiment of FIG. 10 (see also FIG. 1) comprises steam/electricity generation system 1100, wherein steam/electricity generation system 1100 comprises supply system 100, fuel generation system 200, water vapor recovery system 500, turbine 1100.1 and generator 1100.3. Steam 500.19 from water vapor recovery system 500 drives turbine 1100.1 creating rotational energy 1100.2, wherein rotational energy 1100.2 drives generator 1100.3 to provide electrical energy 1100.4.

It is envisioned in an alternate embodiment of the present invention that alternating current could be utilized in lieu of direct current, wherein the pulses could have positive and negative components.

It is additionally contemplated in an alternate embodiment of the present invention that a plurality of arc-hydrolysis reactors 200.1 could be utilized either in a single arc-hydrolysis fuel generator 10 or as a combination of a plurality of arc-hydrolysis fuel generators 10.

It is further envisioned in an alternate embodiment of the present invention that low voltage cold anode 200.4.1 could comprise a conductive material other than carbon fiber 200.24, wherein low voltage cold anode 200.4.1 would be utilized to produce hydrogen and oxygen gases.

It is envisioned in yet another alternate embodiment of the present invention that sea water could be electrolyzed to produce hydrogen and oxygen gases, wherein the gases are then combined via combustion, or the like, to form salt-free water suitable for consumption.

It is contemplated in still another alternate embodiment of the present invention that sewage water could be cleaned by electrolysis in arc-hydrolysis generator 200.1, while concurrently generating fuel.

It is contemplated in still yet another alternate embodiment of the present invention that a single battery 800.6A, or other means for electrical energy storage, could be utilized, or that several batteries, and/or other electrical energy storage means, could be utilized in lieu of batteries 800.6A and 800.6B.

The foregoing description and drawings comprise illustrative embodiments of the present invention. Having thus described exemplary embodiments of the present invention, it should be noted by those skilled in the art that the within disclosures are exemplary only, and that various other alternatives, adaptations, and modifications may be made within the scope of the present invention. Merely listing or numbering the steps of a method in a certain order does not constitute any limitation on the order of the steps of that method. Many modifications and other embodiments of the invention will come to mind to one skilled in the art to which this invention pertains having the benefit of the teachings presented in the foregoing descriptions and the associated drawings. Although specific terms may be employed herein, they are used in a generic and descriptive sense only and not for purposes of limitation. Accordingly, the present invention is not limited to the specific embodiments illustrated herein, but is limited only by the following claims.

1. An arc-hydrolysis gaseous fuel generator comprising:
an arc discharge unit; and
means for induction disposed around said arc discharge unit.

2. The arc-hydrolysis gaseous fuel generator of claim 1, wherein said means for induction is a magnetic energy recovery device.

3. The arc-hydrolysis gaseous fuel generator of claim 1, further comprising at least one carbon electrode.

4. The arc-hydrolysis gaseous fuel generator of claim 3, wherein said at least one carbon electrode comprises carbon fiber.

5. The arc-hydrolysis gaseous fuel generator of claim 3, wherein said at least one carbon electrode is flexible.

6. The arc-hydrolysis gaseous fuel generator of claim 1, further comprising a biomass solution, wherein said biomass solution comprises carbon, hydrogen and oxygen.

7. The arc-hydrolysis gaseous fuel generator of claim 1, further comprising means for preventing corrosion of said means for induction.

8. The arc-hydrolysis gaseous fuel generator of claim 7, wherein said means for preventing corrosion comprises borosilicate glass.

9. The arc-hydrolysis gaseous fuel generator of claim 1, further comprising an internal combustion engine.

10. The arc-hydrolysis gaseous fuel generator of claim 9, further comprising an electrical generator.

11. The arc-hydrolysis gaseous fuel generator of claim 10, further comprising means for energy storage.

12. The arc-hydrolysis gaseous fuel generator of claim 11, wherein said means for energy storage comprises at least one battery.

13. The arc-hydrolysis gaseous fuel generator of claim 11, wherein said means for energy storage comprises a gas pressure tank.

14. The arc-hydrolysis gaseous fuel generator of claim 2, further comprising a steam generation system.

15. The arc-hydrolysis gaseous fuel generator of claim 1, further comprising a gas liquefying system.

16. The arc-hydrolysis gaseous fuel generator of claim 1, wherein said arc discharge unit comprises a water jacket.

17. The arc-hydrolysis gaseous fuel generator of claim 1, further comprising direct current pulses.

18. A method of generating power comprising the steps of:
a. obtaining an arc-hydrolysis unit comprising an arc discharge;
b. disposing an inductor proximate said arc discharge; and
c. recovering energy from said arc discharge within said arc-hydrolysis unit via said inductor.

19. The method of claim 18, further comprising the step of:
hydrolyzing water to produce a gas.

20. The method of claim 18, further comprising the step of:
electrolyzing biomass to produce a gas selected from the group consisting of hydrogen, carbon monoxide, and combinations thereof, wherein said biomass comprises carbon, hydrogen and oxygen.

21. The method of claim 18, further comprising the step of:
storing said gas in a tank.

22. The method of claim 18, further comprising the step of:
burning a gas in an internal combustion engine.

23. The method of claim 18, further comprising the step of:
utilizing a carbon anode.

24. The method of claim 18, further comprising the step of:
storing said energy in a battery.

25. The method of claim 18, further comprising the steps of:
electrolyzing biomass waste; and utilizing said arc-hydrolysis unit to recycle said waste.

26. The method of claim 18, further comprising the step of:
utilizing said arc-hydrolysis unit to disinfect water.

27. The method of claim 18 further comprising the step of:
electrolyzing a biomass solution; and
combusting fuel and oxygen generated from said electrolyzed biomass.

28. An arc-hydrolysis gaseous fuel generator comprising:
an arc-electrolytic reactor comprising a plurality of electrodes, wherein at least one electrode is tungsten and at least one electrode is carbon; and
means for induction, wherein said means for induction is disposed proximate said electrodes.

29. The arc-hydrolysis gaseous fuel generator of claim 28, wherein said at least one tungsten electrode comprises a low voltage cold anode.

30. The arc-hydrolysis gaseous fuel generator of claim 28, wherein said carbon fiber electrode comprises a high voltage hot anode.

31. The arc-hydrolysis gaseous fuel generator of claim 28, further comprising means for condensing and recycling water vapor.

32. The arc-hydrolysis gaseous fuel generator of claim 31, wherein said means for condensing and recycling water vapor comprises an absorption refrigeration unit, and wherein said absorption refrigeration unit is powered by heat generated from an electric arc.

33. The arc-hydrolysis gaseous fuel generator of claim 32, further comprising means to remove said heat.

34. The arc-hydrolysis gaseous fuel generator of claim 28, further comprising a water supply tank, a biomass supply tank, and an electrolyte recirculation tank.

35. The arc-hydrolysis gaseous fuel generator of claim 28, further comprising a water and biomass supply, and a pumping system to collect heat generated.

36. The arc-hydrolysis gaseous fuel generator of claim 28, wherein water and carbon-rich biomass solution are utilized as fuel to generate electrical energy.

37. The arc-hydrolysis gaseous fuel generator of claim 28, further comprising means for reclaiming and recycling water vapor into water.

38. The arc-hydrolysis gaseous fuel generator of claim 37, wherein said means for reclaiming and recycling comprises condensation, and wherein said means for reclaiming and recycling utilizes process heat generated.

39. A method of producing electrical energy, said method comprising the step of:
using an arc-electrolytic system to electrolyze a fuel source selected from the group consisting of water and carbon-rich biomass;
collecting magnetic field energy from said arc-electrolytic system via an inductor;
converting said magnetic field energy into electrical energy;
storing said electrical energy in a battery.

40. The method of claim 39, further comprising the steps of:
extracting hydrogen and carbon monoxide gaseous fuels from said fuel source; and
storing said gaseous fuels in a pressurized tank; and
converting said gaseous fuels into mechanical energy via combustion.

41. The method of claim 39, further comprising the step of:
utilizing direct current pulses.

42. A process for the recycling of carbon and oxygen comprising the steps of:
producing fuel from water and biomass via arc-hydrolysis, wherein said fuel comprises carbon and oxygen;
burning said fuel in an internal combustion engine; and
recovering carbon and oxygen from said burning of said fuel.

43. An energy-efficient fuel generation system, comprising:
a liquid fuel source material contained in a pressurized vessel, wherein said pressurized vessel is a circulating cooling chamber;
a power supply;
an arc-hydrolysis device comprising a temperature control system, a pressure control system, a submerged low voltage cold anode, a submerged high voltage hot anode, and an arc point defined between said anodes, said arc-hydrolysis unit powered by said power supply and said arc-hydrolysis unit adapted to generate a high voltage pulse proximate said arc point;
a liquid fuel source transport system adapted to enable flow of said liquid fuel source material between said pressurized vessel and said arc-hydrolysis device, wherein said liquid fuel source material is ionized into gaseous fuel at said arc point, and wherein heat and magnetic energy are coincidentally generated;
at least one battery;
a metal collector, said metal collector carried proximate said arc point, and said metal collector adapted to collect magnetic energy and to transmit said collected magnetic energy to said at least one battery;
a water vapor recovery system comprising an absorption refrigeration unit and a recovered water transport system adapted to enable flow of said recovered water to said pressurized vessel;
a storage tank for said gaseous fuel;
a gaseous fuel transport system adapted to enable flow of said gaseous fuel between said arc-hydrolysis unit and said storage tank;
a mixing tank for mixing said gaseous fuel with air;
an internal combustion engine having an exhaust, wherein said exhaust is directed to said water vapor recovery system, wherein ignition of said internal combustion engine is facilitated via said at least one battery;
a mixed fuel transport system adapted to enable flow of said mixed fuel between said mixing tank and said internal combustion engine, wherein said internal combustion engine is fueled by said mixed fuel; and,
an electrical generator, said electrical generator driven by said internal combustion engine, wherein at least a portion of electrical energy produced by said electrical generator is collected and utilized to power said power supply.
